(19) United States
(12) Patent Application Publication
(10) Pub. No.: US 2026/0077364 A1
(43) Pub. Date: Mar. 19, 2026

(54) COLLECTOR COMPOSITION FOR BENEFICIATING CARBONACEOUS PHOSPHATE ORES

(71) Applicant: ArrMaz Products Inc., Mulberry, FL (US)

(72) Inventors: Guoxin WANG, Mulberry, FL (US); Zhengxing GU, Mulberry, FL (US); Pingkeng WU, Mulberry, FL (US); Yusheng GAO, Mulberry, FL (US); Kevin RASKO, Mulberry, FL (US); Eric GUITIERREZ, Mulberry, FL (US)

(21) Appl. No.: 19/110,442

(22) PCT Filed: Sep. 18, 2023
(86) PCT No.: PCT/US2023/032976

§ 371 Date: Mar. 11, 2025

(30) Foreign Application Priority Data
Sep. 22, 2022 (EP) 22197195.5

(51) Int. Cl. B03D 1/018; B03D 1/008; B03D 1/012

(52) U.S. Cl. CPC B03D 1/018; B03D 1/008; B03D 1/012; B03D 2201/02; B03D 2203/06

(57) ABSTRACT

The invention is related to a collector composition for the beneficiation of phosphate ores, particularly those with high content of carbonate impurities. The collector may be a combination of chemicals, comprising: (1) any kind of fatty acids, e.g., conventional fatty acid, saponified fatty acid, or modified fatty acid; (2) chemicals with sulfonate or sulfate groups, such as dodecylbenzene sulfonic acid (DDBSA) or its salt, sodium dodecyl sulfate (SDS), sodium lauryl sulfate (SIS), sodium coco sulfate (SCS), etc.; (3) phosphorous-bearing inorganic acids or salts, such as sodium tripolyphosphate (STPP), sodium hexametaphosphate (SFMP), trisodium phosphate (TSP), Tetrasodiumpyrophosphate (TSPP), etc.; (4) alkoxylated alcohols, preferably ethoxylated C8-C24 linear or branched fatty alcohols with a degree of ethoxylation higher than five; and (5) modifier compositions selected from one or more of the modifier agents such as insoluble oils, silicones, fatty alcohols, esters, glycols, etc.

### BACKGROUND OF THE INVENTION

### Cross Reference

Not Applicable.

### Field of the Invention

This invention relates generally to a collector composition for beneficiating phosphate ores, especially those with high carbonaceous impurities.

### Description of the Related Art

The growing world population constantly imposes an increasingly high demand on fertilizers, of which phosphate is a critical ingredient. The efficient beneficiation of phosphate ores is thus crucial in meeting the high fertilizer demand to feed the world. Since the high-quality siliceous phosphate resources is limited, it is essential for the phosphate industry to mine low-grade phosphate ores with high impurity.

Common impurities that co-exist with the phosphate rocks are silica, clays, calcium and magnesium carbonates, iron minerals, etc. Among the impurities, calcium and magnesium carbonate are considered as the most problematic because of the similar physical and chemical properties, which make the separation of the phosphate rocks from the impurities difficult. Calcium and magnesium carbonate also disturb the downstream acid treatment of the phosphate concentrate. In fact, most phosphate reserves in the world including deposits in China, Morocco, Saudi Arabia, Tunisia, Israel. Mongolia, Kazakhstan, USA, etc., are associated with high amounts of carbonate impurities.

The most widely adopted technique in beneficiating phosphate ores is froth flotation, whose efficiency largely depends on the ability of the flotation collectors to differentiate the surface hydrophobicity of the valuable minerals and the unwanted impurities in the ore. Therefore, the development of collectors is the key for achieving satisfactory separation performance in froth flotation. Previously, the phosphate rocks concentration target was at least 29.5% P₂O₅ for an effective wet process of phosphoric acid production.

In U.S. Pat. No. 10,434,520, a collector composition for the effective beneficiation of phosphate ores containing high carbonate impurities is disclosed. The collector comprised of fatty acids, sulfonate or sulfate groups comprising dodecylbenzene sulfonic acid or salt, and phosphorous-bearing inorganic acid or salt.

The use of alkoxylated alcohols as secondary collector or emulsifier to boost the flotation efficiency of fatty acids containing collectors is known in prior art. U.S. Pat. No. 4,789,466 taught the use of alkoxylated C8-C22 fatty alcohol together with at least one anionic, cationic, or amphoteric surfactant for separating non-sulfidic ores. The anionic surfactant can be fatty acid, alkyl sulfates, alkyl sulfosuccinates, alkyl sulfosuccinamates, alkylbenzenesulfonates, alkyl sulfonates, petroleum sulfonates, and acyl lactylates. The alkoxylated alcohol is both propoxylated and ethoxylated. U.S. Pat. No. 10,376,901 taught the use of branched C12-C16 fatty alcohol alkoxylates with a degree of ethoxylation of up to three as secondary collector for phosphate beneficiation. The primary collector is selected from the group of amphoteric and anionic surface-active compounds. The anionic surfactants consist of fatty acids, sulfonates, alkyl phosphates, and alkyl sulfates. WO2018197476A1 claimed that the alkoxylated branched alcohols with a degree of alkoxylation from 0.1 to 15 and another alkoxylated branched alcohols with a degree of alkoxylation from 1 to 30 can be used in combination with fatty acids or their derivatives for the beneficiation of phosphate containing ores. WO2020083793A1 used alkoxylated C9-C18 alcohols with a degree of ethoxylation from 2 to 10 and a degree of propoxylation from 1 to 10 to improve the efficiency of fatty acid collector in phosphate flotation. The alkoxylated alcohol can be linear or branched. The publication also disclosed additionally, another alkoxylated branched alcohol can be used. WO2017162563A2 disclosed a secondary collector for the froth flotation of non-sulfidic ores. The secondary collector is a mixture of branched C12-C16 fatty alcohol with a degree of ethoxylation up to four and alkoxylated nonionic hydrocarbon with a degree of ethoxylation higher than three. The alkoxylated nonionic hydrocarbon can be C8-C24 linear or branched alcohols with an ethoxylation from 4 to 30. The primary collector to be used with the secondary collector is selected from the group of amphoteric and anionic surface-active compounds.

### SUMMARY OF THE INVENTION

In general, the invention relates to a collector for beneficiating carbonaceous phosphate ores comprising a fatty acid, a compound including at least one sulfonate or sulfate group, a phosphorous-bearing inorganic acid or salt, alkoxylated alcohol, and a modifier compound. In a particular embodiment, the collector may comprise a majority, by weight, of the fatty acid comprising C4-C22 containing hydrocarbons with a terminal carboxyl group fatty acid, saponified fatty acid, modified fatty acid and combinations thereof. Embodiments of the collector may include approximately 0.5% to 20% by weight of a compound that includes at least one sulfonate or sulfate group. Examples of the sulfonate or sulfate include compounds which comprise dodecylbenzene sulfonic acid or salt (DDBSA), sodium dodecyl sulfate (SDS), sodium lauryl sulfate (SLS), sodium coco sulfate (SCS) and combinations thereof. Embodiments may also include approximately 0.1% to 10% by weight of the phosphorous-bearing inorganic acid or salt. Further embodiments may include approximately 0.1% to 5% by weight of the alkoxylated alcohol. Embodiments may include approximately 0.1% to 10% by weight of the modifier compound.

While the fatty acid may comprise conventional fatty acid having C4-C22 hydrocarbons with a terminal carboxyl group, saponified fatty acid, modified fatty acid and combinations thereof, the fatty acid may not be linear. Further, the fatty acid may be monomer.

The compound which includes at least one sulfonate or sulfate group may comprise at least one selected from dodecylbenzene sulfonic acid or salt (DDBSA), sodium dodecyl sulfate (SDS), sodium lauryl sulfate (SLS), sodium coco sulfate (SCS) and combinations thereof.

The phosphorous-bearing inorganic acid or salt may comprise at least one selected from sodium tripolyphosphate (STPP), pyrophosphoric acid, sodium phosphate, sodium pyrophosphate and combinations thereof.

The alkoxylated alcohol may be propoxylated or ethoxylated or both propoxylated and ethoxylated. Further, the alkoxylated alcohol may comprise C8-C24 linear or branched alcohol. Preferably, the alkoxylated alcohol may be ethoxylated C8-C24 linear or branched fatty alcohol with a degree of ethoxylation of at least about five, preferably more than about five.

Suitable modifier compositions may include modifier agents such as insoluble oils, silicones, fatty alcohols, esters and glycols. Preferably, the modifier compositions may be selected from one or more of hydrocarbons, polyethylene glycol fatty acid esters, primary alcohol, silicone polyether and combinations thereof.

In a second embodiment, the invention relates to an ore beneficiation process for separating alkaline earth metal carbonate impurities from phosphate ore, the process comprising: pulping ore with water to about 20% to 60% solids to produce an ore slurry; reagentizing the ore slurry to produce a reagentized slurry by adding a pH modifier such that the ore slurry has a pH of about 4 to about 6 and the collector described above; subjecting the reagentized slurry to flotation to produce an overflow and an underflow; separating the overflow as waste; and collecting the underflow as phosphate concentrate. Reagentizing may not include introducing a separate phosphate depressant. The pH modifier may comprise H₃PO₄, H₂SO₄, H₂SiF₆ and combinations thereof. An example of preferred embodiments of the pH modifier are mixtures of H₃PO₄ and H₂SO₄ or other acids that lower pH.

All or two and more of the fatty acid, the compound with sulfonate or sulfate groups, the phosphorous-bearing chemical, the alkoxylated alcohol and the modifier may be added separately. Alternately, the fatty acid, the chemical with the sulfonate or sulfate group, the phosphorous-bearing chemical, the alkoxylated alcohol and modifier may be combined before being added to the ore slurry.

In a third embodiment, the invention relates to a flotation method for removing carbonate impurities from phosphate ores, the method comprising: producing an ore slurry comprising phosphate ore and the collector described above; and subjecting the ore slurry to flotation. The ore slurry may further comprise a pH modifier such that the ore slurry has a pH of about 4 to about 6. The pH modifier may comprise H₃PO₄, H₂SO₄, H₂SiF₆, or mixtures of H₃PO₄ and H₂SO₄, or other acids that lower pH. The ore slurry may further comprise water such that the ore slurry has about 20% to 60% solids prior to introducing the collector. The ore slurry may not comprise a separate phosphate depressant. Subjecting the ore slurry to flotation may produce an underflow and an overflow, and the method may further comprise separating the overflow as waste and collecting the underflow as phosphate concentrate.

The fatty acid, the chemical with sulfonate or sulfate groups, the phosphorous-bearing chemical of the collector, the alkoxylated alcohol and modifier may be added separately to the ore slurry or may be combined before being added to the ore slurry. The alkoxylated alcohol improves the flotation performance of the collectors comprising of fatty acids, sulfonate or sulfate groups comprising dodecylbenzene sulfonic acid or salt, and phosphorous-bearing inorganic acid or salt. Additionally, the modifier compound comprising at least one of hydrocarbons, polyethylene glycol fatty acid esters, primary alcohol, and silicone polyether can further enhance the performance of the collector, particularly in the presence of fine phosphate rock particles.

The disclosed collector may also be used in a reverse floatation process, in which the phosphate is in the overflow and the waste stream is the underflow.

The disclosed collector generates higher P₂O₅ concentrate grades and recoveries as compared to that commonly used collector.

The disclosed collector can be used to avoid foaming problems when excessive fine particles are present.

The disclosed collector composition has particular application for batches with excessive fines. Fines may be defined as particle size of less than 37 microns. One non-limiting example of such particles include particles of about 20 microns or less.

The disclosed collector has a notable application for batch sizes with at least about 15% by weight of fines. Examples of suitable amounts of fines may include as high as at least about 25% by weight and at least about 35% by weight. In one specific embodiment, at least about 15% by weight of the fines comprises particles sized about 20 microns or less.

Advantages of using the disclosed collector include reduced foaming, such that the floatation process may require at least about 25% less floatation volume for the same amount of ore, preferably at least about 50% less floatation volume, and even more preferably, less than 50% of the floatation volume.

The advantages also include reduced water usage in the floatation process. The amount of water reduction may be at least about 25% by volume.

The above ore batches with excess fines may be processed without desliming the ore.

### Aspects

At first aspect comprises an ore beneficiation process for separating alkaline earth metal carbonate impurities from phosphate ore. The process includes forming an ore slurry; reagentizing the ore slurry to produce a reagentized slurry by adding a collector. The collector comprises a fatly acid, where the fatly acid comprises a majority of the collector; a compound with one or more sulfonate or sulfate groups, the compound with sulfonate or sulfate groups comprises at least one selected from the group of dodecylbenzene sulfonic acid (DDBSA) or salt, sodium dodecyl sulfate (SDS), sodium lauryl sulfate (SLS), sodium coco sulfate (SCS), or a combination thereof, where the compound with sulfonate or sulfate groups comprises 0.5% to 20% of the collector, and a phosphorous-bearing chemical, where the phosphorous-bearing chemical comprises at least one selected from the group of sodium phosphate, sodium pyrophosphate, sodium tripolyphosphate (STPP), other sodium polyphosphate salt, their partially acidified or fully acidified forms, or a combination thereof. The collector may also comprise an alkoxylated alcohol and a modifier. The process further includes subjecting the reagentized slurry to flotation to produce a phosphate concentrate.

In the first aspect the reagentizing step optionally may not include introducing a separate phosphate depressant.

In a second aspect the pH modifier of the first aspect may comprises H₃PO₄, H₂SO₄, a mixture of H₃PO₄ and H₂SO₄, or other acids that lower pH.

In a third aspect, for the process of either one of aspect one or two, the at least one of the fatty acid, the chemical with sulfonate or sulfate groups, the phosphorous-bearing chemical, the alkoxylated alcohol or the modifier are added separately.

In a fourth aspect applicable to either one of aspects 1 or 2, at least two of the fatty acid, the chemical with sulfonate or sulfate groups, the phosphorous-bearing chemical, the alkoxylated alcohol and the modifier are combined before being added to the ore slurry.

In aspect five, the fatty acid of anyone of aspects 1-4 may comprises a conventional fatty acid, or a saponified fatty acid.

In aspect six, the fatty acid of anyone of aspects 1-5 is not linear.

Aspect seven includes a flotation method for removing carbonate impurities from phosphate ores. The method includes producing an ore slurry comprising phosphate ore and a collector. The method may further include subjecting the ore slurry to flotation. The collector includes at least one fatty acid, at least one compound including one or more sulfonate or sulfate groups, at least one phosphorous-bearing inorganic acid or salt, at least one alkoxylated alcohol, and at least one modifier compound.

The ore slurry of aspect seven may further comprise a pH modifier such that the ore slurry has a pH of about 4 to about 6.

In an eighth aspect, the ore slurry of the seventh aspect may further comprises water such that the ore slurry has about 20% to 60% solids prior to introducing the collector.

In the ninth aspect, the subjecting the are slurry to flotation of aspects 7 or 8 produces an underflow and an overflow. The method may further comprise separating the overflow as waste; and collecting the underflow as phosphate concentrate.

10. In anyone of aspects 7-9 the at least one of the fatty acid, the chemical with sulfonate or sulfate groups, the phosphorous-bearing chemical, the alkoxylated alcohol and the modifier are added separately to the ore slurry.

11. In anyone of aspects 7-10 at least two of the fatty acid, the chemical with sulfonate or sulfate groups, the phosphorous-hearing chemical, the alkoxylated alcohol and the modifier are combined before being added to the ore slurry.

### DETAILED DESCRIPTION OF THE INVENTION

In general, the invention relates to a novel collector for use in a flotation process for removing carbonate impurities from phosphate ores. The collector may be a combination of chemicals, including (1) one or more fatty acid products, such as fatty acids having a C4-C22 hydrocarbons with a terminal carboxyl group, saponified fatty acid, modified acid and combinations thereof; (2) one or more compounds with a sulfonate or sulfate group, such as dodecylbenzene sulfonic acid or salt (DDBSA), sodium coco sulfate (SCS), sodium dodecyl sulfate (SDS), sodium lauryl sulfate (SLS), and combinations thereof; (3) one or more phosphorous-bearing inorganic acid or salt, such as pyrophosphoric acid, sodium phosphate, sodium pyrophosphate, sodium tripolyphosphate (STPP) and combinations thereof; (4) one or more alkoxylated alcohols, such as propoxylated or ethoxylated or both propoxylated and ethoxylated. The alkoxylated alcohol may include C8-C24 linear or branched alcohols; and (5) one or more modifier compositions, such as insoluble oils, silicones, fatty alcohols, esters, glycols and combinations thereof. These components may be mixed together as one product or may be added separately but are generally added at the same time, either simultaneously or sequentially, at the conditioning step prior to flotation.

Suitable fatty acids may include straight-chain fatty acids, branched chain fatty acids, cyclic fatty acids, saturated, unsaturated, aromatic containing fatty acids containing from 12 to 22 carbon atoms. Examples of sources of the fatty acid include vegetable or animal fats and oils. Tall oil fatty acid (TOFA) and canola fatty acid are preferred. The fatty acids may be present in salt form. Preferred amounts of fatty acid/fatty acid salts included in the composition may range from about 51% to 99% by weight, about 55% to 98% by weight, about 60% to 97% by weight, about 65% to 96% by weight, about 70% to 95% by weight and about 80 to 90% by weight.

In particular, the compound with sulfonate or sulfate group may be dodecylbenzene sulfonic acid or salt (DDBSA). DDBSA may not work as a collector when used alone, but surprisingly may be effective when used in combination with a fatty acid product and a phosphorous-bearing chemical. In one embodiment, the preferred fatty acid product for use with the sulfonate or sulfate group containing compound may be linear. Alternately, the fatty acid is not required to be linear. In another particular embodiment, the fatty acid may be a monomer, which may be a cyclic or branched fatty acid.

Regarding the one or more alkoxylated alcohols, such as propoxylated, ethoxylated, butoxylated or combinations thereof, further examples of suitable alkoxylated alcohol in the field of C8-C24 linear or branched alcohols include fatty alcohols, such as C10-C20 ethoxylated alcohols, even further C12-C18 ethoxylated alcohols. Suitable ethoxylation includes at least 3 EO, preferably at least 5 EO, even more preferred at least 7 EO, even further preferred as high as at least about 10 EO.

Regarding preferred concentrations of components, the concentration of the fatty acid is preferably a majority of the collector composition by weight. The fatty acid may comprise at least about 50 wt % of the collector composition, more preferably at least about 55 wt %, even further preferred at least about 60 wt % of the collector composition. Preferably, the collector comprises less than about 90 wt % of the fatty acid.

With respect to the compound comprising a sulfonate or sulfate group, the concentration of the compound is no more than about 25 wt %, preferably at least about 0.1 up to 20%, even more preferably at least about 2 to 20 wt %. As for the phosphorous bearing inorganic acid or salt (“P-cmpd”), the collector may comprise up to about 15 wt % of the P-cmpd, preferably at least about 0.1 to 10 wt %, even more preferably at least about 0.5-10 wt %.

The alkoxylated alcohol may be present in the collector from about 0.1 to 10 wt %, preferably about 0.5 to 10 wt %, even more preferred about 1 to 5 wt %. Lastly, the modifier may be present in the collector at a concentration of up to about 10 wt %, preferably about 0.1 to 10 wt %, even more preferably about 0.5 to 5 wt %.

The new collector may float carbonate minerals from phosphate in an acidic pH environment with either H₃PO₄, H₂SO₄, H₂SiF₆, and combinations thereof. One particular embodiment is a mixture of H₃PO₄ and H₂SO₄. One or more acids can be used to lower pH, or a combination thereof and any ratio may be used as the pH modifier. The collector described herein may significantly improve separation efficiency with better recovery and selectivity. All five of the fatty acid, compound with sulfonate or sulfate group, phosphorous-bearing inorganic acid or salt, alkoxylated alcohol, and modifier compositions may be included in the collector.

It has been discovered that the addition of the alkoxylated alcohol can enhance the flotation efficiency of the collector.

### EXAMPLES

The present invention is further illustrated by the following example. In order that those skilled in the field may better understand how the present invention can be practiced, the following examples are given by way of illustration only and not necessarily by way of limitation. Regarding the percentages of components, the percentages are by weight (wt %).

### Example I

A phosphate ore containing high carbonate mineral impurities was used in the example. The sample was ground and sized to prepare a minus 300 microns flotation feed with 19 wt % minus 20 micron fine particles. The feed sample was conditioned in a conditioning tank with a carbonate mineral collector at pH 4.5-5.5 using H₃PO₄ as pH modifier for one minute. The conditioned slurry was transferred to a flotation cell, and aerated for flotation. During conditioning and flotation, pH was maintained by adding diluted acid. In this example, a saponified fatty acid was used. One (1) kg of saponified fatty acid per ton of feed was used alone as a collector (“Control-1”). A phosphate concentrate containing 27.2% P₂O₅ was obtained from a feed of 15.8% P₂O₅ at 80.3% recovery. A mixture of 85% fatty acid soap, 10% DDBSA, and 5% STPP (sodium pyrophosphate, sodium tripolyphosphate) was used a collector as Control-2. A phosphate concentrate with 28.5% P₂O₅ was achieved at 82.1% recovery. A mixture of 82.5% fatty acid soap, 9.7% DDBSA, 4.9% STPP, 1% ethoxylated fatty alcohol, and 2% modifier compositions was used a collector (Invention). A phosphate concentrate with 28.6% P₂O₅ was achieved at 83.5% recovery. It can be seen that the invented collector with alkoxylated alcohol and modifier compositions significantly improve the phosphate recovery. In addition, the invented collector generates much less foam in the tail collection after flotation when the feed contains excess amount of fine particles. The disclosed collector may be used to reduce the amount of forth by at least about 25%, preferably at least about 50% less froth and even more preferably more than about 50% less froth.

TABLE I

| | | | | | | Froth |
|---|---|---|---|---|---|---|
| | Dosage | Flotation | | Grade | Recovery | collected, |
| Collector | kg/t | pH | Product | P₂O₅% | % | ml |
| Fatty Acid Soap | 1.0 | 4.5-5.5 | Concentrate | 27.2 | 80.3 | 1500 |
| (Control-1) | | | Tail | 5.9 | | |
| | | | Feed | 15.8 | | |
| 85% Fatty Acid | 1.0 | 4.5-5.5 | Concentrate | 28.5 | 82.1 | 1750 |
| Soap + 10% | | | Tail | 5.2 | | |
| DDBSA + 5% | | | Feed | 15.8 | | |
| STPP (Control-2) | | | | | | |
| 82.5% Fatty Acid | 1.0 | 4.5-5.5 | Concentrate | 28.6 | 83.5 | 750 |
| Soap + 9.7% | | | Tail | 4.8 | | |
| DDBSA + 4.8% | | | Feed | 15.8 | | |
| STPP + 1% | | | | | | |
| Ethoxylated | | | | | | |
| Alcohol + 2% | | | | | | |
| Modifier | | | | | | |
| (Invention) | | | | | | |

1. A collector for beneficiating carbonaceous phosphate ores comprising
a. at least one fatty acid,
b. at least one compound including one or more sulfonate or sulfate groups,
c. at least one phosphorous-bearing inorganic acid or salt,
d. at least one alkoxylated alcohol, and
e. at least one modifier compound.

2. The collector of claim 1, wherein the collector comprises: at least about 48 percent by weight of the fatty acid; approximately 0.5 percent to 25 percent by weight of the sulfonate or sulfate groups compound; approximately 0.1 percent to 20 percent by weight of the phosphorous-bearing inorganic acid or salt; approximately 0.1 percent to 10 percent by weight of the alkoxylated alcohols; and approximately 0.1 percent to 20 percent by weight of the modifier compound.

3. The collector of claim 1 wherein the fatty acid comprises at least one from the group of conventional fatty acid, saponified fatty acid, modified fatty acid and combinations thereof.

4. The collector of claim 1 wherein the fatty acid is not linear.

5. The collector of claim 1 wherein the fatty acid comprises a monomer.

6. The collector of claim 1 wherein the sulfonate or sulfate group including compound comprises a least one selected from the group of dodecylbenzene sulfonic acid or salt (DDBSA), sodium dodecyl sulfate (SDS), sodium lauryl sulfate (SLS), sodium coco sulfate (SCS) and combinations thereof.

7. The collector of claim 6 wherein the sulfonate or sulfate group including compound comprises dodecylbenzene sulfonic acid or salt (DDBSA).

8. The collector of claim 1 wherein the phosphorous-bearing inorganic acid or salt comprises at least one selected from the group of sodium tripolyphosphate (STPP), pyrophosphoric acid, sodium phosphate, sodium pyrophosphate and combinations thereof.

9. The collector of claim 1 wherein the alkoxylated alcohol includes at least one of propoxylated units ethoxylated units or both propoxylated and ethoxylated units.

10. The collector of claim 1 wherein the alkoxylated alcohol comprises a C8-C24 linear compound or branched alcohol compound.

11. The collector of claim 1 wherein the alkoxylated alcohol comprises a C8-C24 linear or branched fatty alcohol.

12. The collector of claim 1 wherein a degree of ethoxylation comprises at least about five.

13. The collector of claim 1 wherein the alkoxylated alcohol comprises a C14-C20 primary alcohol with a degree of ethoxylation greater than about five.

14. The collector of claim 1 wherein the modifier compound comprises at least one selected from the group of insoluble oils, silicones, fatty alcohols, esters, glycols and combinations thereof.

15. The collector of claim 1 wherein the modifier compound is at least one selected from the group of hydrocarbons, polyethylene glycol fatty acid esters, primary alcohol, silicone polyether and combinations thereof.

16. The collector of claim 1 wherein the concentration of the fatty acid comprises more than about 55 percent by weight.

17. The collector of claim 1 wherein the concentration of the sulfonate or sulfate groups including compound comprises up to about 20 percent by weight of the collector.

18. The collector of claim 1 wherein the phosphorous-bearing inorganic acid or salt comprises up to about 10 percent by weight of the collector.

19. The collector of claim 1 wherein the alkoxylated alcohol comprises up to about 5 percent by the weight of the collector.

20. The collector of claim 1 wherein the modifier compound comprises up to about 10 percent by weight of the collector.

21. The collector of claim 1, wherein the collector comprises: at least about 55 percent by weight of the fatty acid and the fatty acid comprises at least one selected from C4-C22 hydrocarbon containing fatty acids, saponified fatty acids, modified fatty acids and combinations thereof; up to about 20 percent by weight of the compound including the sulfonate or sulfate groups, wherein the compound comprises at least one selected from the group of dodecylbenzene sulfonic acid or salt (DDBSA), sodium dodecyl sulfate (SDS), sodium lauryl sulfate (SLS), sodium coco sulfate (SCS) and combinations thereof; up to about 10 percent by weight of the phosphorous-bearing inorganic acid or salt, wherein the phosphorous-bearing inorganic acid or salt comprises at least one selected from sodium tripolyphosphate (STPP), pyrophosphoric acid, sodium phosphate, sodium pyrophosphate and combinations thereof; approximately up to 5 percent by weight of the alkoxylated alcohol wherein the alcohol selected from the group of C8-C24 linear or branched alcohols; and approximately up to 10 percent of the modifier compound, wherein the modifier compound includes at least one of insoluble oils, silicones, fatty alcohols, esters, glycols and combinations thereof.
